(19) United States
(12) Patent Application Publication
(10) Pub. No.: US 2004/0054674 A1
(43) Pub. Date: Mar. 18, 2004

(54) Enabling a web application to access a protected file on a secured server

(76) Inventors: Keith A. Carpenter, Leander, TX (US); Amy C. Beisenherz, Pflugerville, TX (US)

Correspondence Address: HAMILTON & TERRILE, LLP, P.O. BOX 203518, AUSTIN, TX, 78720, US

(21) Appl. No.: 10/242,898

(22) Filed: Sep. 13, 2002

(51) Int. Cl. G06F 17/30

(52) U.S. Cl. 707/9; 707/10

(57) ABSTRACT

A document exchange environment for allowing a user to access documents. The document exchange environment includes a web server, a document vault database and a file server. The document vault database is coupled to the web server and stores information regarding whether a user is authorized to access a document file. The file server is coupled to the web server and provides a user access to the document file via the web server based upon the information regarding whether the user is authorized to access the document file.

### BACKGROUND OF THE INVENTION

1. Field of the Invention

The present invention relates generally to document processing and more particularly to web based document exchange.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One use of an information handling system is to provide access to the World Wide Web of the Internet. In the Web environment, client machines effect transactions to Web servers using a Hypertext Transfer Protocol (HTTP), which is a known application protocol providing users access to files (e.g., text, graphics, images, sound, video, etc.) using a standard page description language known as Hypertext Markup Language (HTML). HTML provides basic document formatting and allows the developer to specify “links” to other servers and files. In the Internet paradigm, a network path to a server is identified by a Uniform Resource Locator (URL) having a special syntax for defining a network connection. Use of an HTML-compatible browser at a client machine involves specification of a link via the URL. In response, the client makes a request to the server identified in the link and receives in return a document formatted according to HTML. A Web server is usually a standalone file server that services various Web document requests.

Inherent in a web-based document exchange application is the issue of security. Typically, allowing a web application to access a file means one of three things: Opening the security on file(s) to the point where all users of the application have access through the file's URL (essentially, no security); manually assigning user/group permissions to the file at the operating system level; and using a client-installed application to access the files securely.

One example of a document exchange application is Document Vault document exchange application v.2.0 provided by Dell Computer Corporation. The Document Vault is a web based file upload/download utility. The application provides document exchange application rudimentary security that may be defeated by determining a file's URL and folder password. All files are left exposed to all users and protected only by making the file URLs non-obvious. After the user's company is determined, there is no user/group level security available aside from folder-specific passwords. These passwords are kept in plain text in a location accessible through the application.

Email is a known method for file exchange. The email file exchange method provides little security for the transfer without substantial infrastructure (keys). Also, the email file exchange method is a push-only delivery method that requires all recipients be known. The email file exchange method provides no centralized and available archive of files. Also, with the email file exchange method, there is no logical grouping of files (such as a folder tree) and usually there is a limit on the size of files that can be transferred via email.

SecureFTP is a known file transfer protocol that allows for secure transfer of files, file archival, and logical grouping. The SecureFTP file transfer protocol generally requires client installation aside from the web browser; may be difficult to integrate with a Lightweight Directory Access Protocol (LDAP) at user level; lacks detailed file-level security attributes; and does not provide for easy delegation of security administration.

There are a number of patents relating to document exchange. For example, Rich et al. U.S. Pat. No. 5,918,228 discloses enabling a web server to impersonate a user of a distributed file system to obtain secure access to supported web documents. Also, for example, Ault et al. U.S. Pat. No. 6,338,064 discloses enabling a web server running a “closed” native operating system to impersonate a user of a web client to obtain a protected file. The Ault et al. solution relates to a distributed file system on Windows NT, and uses a separate application to choose a temporary user ID that has access to the file.

### SUMMARY OF THE INVENTION

In accordance with the present invention, a document exchange application is provided in which security is integral to the document exchange application. Therefore, opening the security on all files is not an option. The security is transparent to the number of files and users. Additionally, the document exchange application provides the security without the need for client installation. The document exchange application provides file-level security to any number of files without manual maintenance or client installation.

The document exchange application includes user/group security and an algorithm for determining access that accomplishes individual file security. After successfully determining the individual's access, the document exchange web application gains access to the centralized file server to retrieve or store the file on behalf of the user.

In one embodiment, the invention relates to a document exchange environment for allowing a user to access documents. The document exchange environment includes a web server, a document vault database and a file server. The document vault database is coupled to the web server and stores information regarding whether a user is authorized to access a document file. The file server is coupled to the web server and provides a user access to the document file via the web server based upon the information regarding whether the user is authorized to access the document file.

In another embodiment, the invention relates to a document exchange application for enabling secure exchange of document files. The document exchange application includes a security database and algorithm portion, and an infrastructure portion. The security database and algorithm portion provides access to information regarding whether a user is authorized to access a document file. The infrastructure portion provides a user access to the document file based upon information regarding whether the user is authorized to access the document file.

In another embodiment, the invention relates to an information handling system which includes, a processor, a memory coupled to the processor and a document exchange application stored on the memory. The document exchange application contains instructions coded to enable secure exchange of document files. The document exchange application includes a security database and algorithm portion and an infrastructure portion. The security database and algorithm portion provides access to information regarding whether a user is authorized to access a document file. The infrastructure portion provides a user access to the document file based upon the information regarding whether the user is authorized to access the document file.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic block diagram of a document exchange environment.

FIG. 2 shows a schematic block diagram of an information handling system.

FIG. 3 shows a screen presentation of a front end of a program which provides access to document exchange application.

FIG. 4 shows a screen presentation of a front end of a document exchange application.

FIG. 5 shows a screen presentation of security portion of a document exchange application.

FIG. 6 shows a screen presentation of a folder detail/history portion of a document exchange application.

FIG. 7 shows a screen presentation of a file detail/history portion of a document exchange application.

FIG. 8 shows a screen presentation of a subscription portion of a document exchange application.

### DETAILED DESCRIPTION

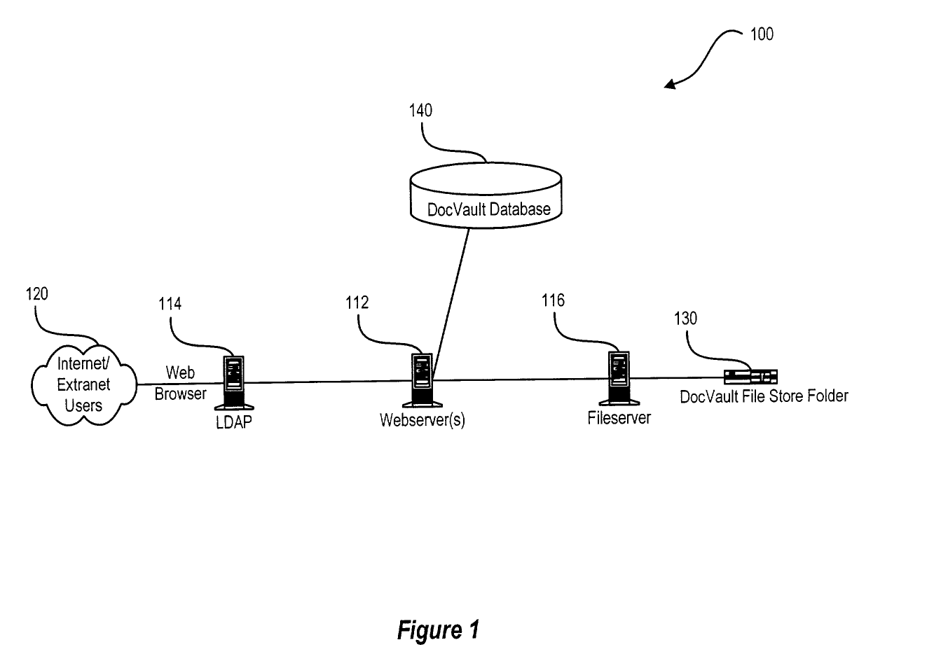

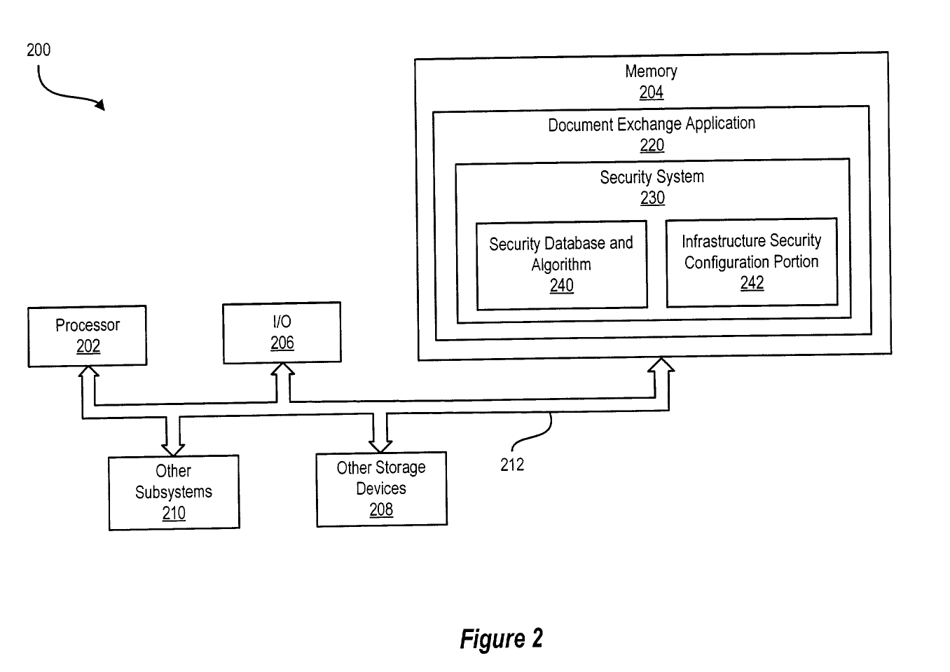

FIG. 1 shows a schematic block diagram of a document exchange environment. The document exchange environment 100 includes a document vault database 140 which is coupled to a document vault web server 112. A document exchange application (see FIG. 2) is stored on and executed by the document vault web server 112. The document vault web server 112 is coupled to an authentication system 114, such as e.g., an LDAP system, and to a file server 116. Users access the LDAP system 114 via the internet 120 using a web browser. The file server 116 is coupled to a document vault file store system 130. The web server 112 is coupled to a document vault database 140.

Referring to FIG. 2, a block diagram of the document vault web server 112 is shown. Document vault web server 112 is, for example, an information handling system 200. The web server 112 includes a processor 202, input/output (I/O) devices 206, such as a display, a keyboard, a mouse, and associated controllers, memory 204 which includes both volatile memory, such as random access memory (RAM) as well as non-volatile memory, such as one or more hard disk drives, and other storage devices 208, such as a floppy disk drive and other memory devices, and various other subsystems 210 all interconnected via one or more buses 212.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

A document exchange application 220 is stored on memory 204 and executed by processor 202. The document exchange application 220 enables secure document upload/download (i.e., exchange) between a plurality of companies storing documents and a plurality of companies accessing the documents. The document exchange application 220 provides a reliable, effective and secure document exchange system. The document exchange application 220 includes a security system 230 which prevents unauthorized access to documents. The security system 230 includes a security database and algorithm portion 240 and an infrastructure security configuration portion 242. The security database and algorithm portion 240 is maintained by the document exchange application 220. The infrastructure security configuration portion 242 prevents a user from bypassing the application security system 230 and directly accessing files which are stored on the document vault file store system 130 using a URL.

The document exchange application 220 determines a user's level of access (read, write, delete, or administrator) to a file or folder using a security algorithm within the security database and algorithm portion 240. The algorithm determines whether the user is explicitly assigned to the requested file or folder. If the user account isn't assigned, the algorithm checks for the existence of the user's group (for example, Dell or non-Dell) and determines the level of access for that group. Failing that check indicates that the user is unauthorized to access the file, and the document exchange application notifies the user as such.

The security database and algorithm portion 240 is coupled with the infrastructure security configuration portion 242 to ensure that only users who access the file server 116 via the interface of document exchange application 220 can access files, therefore enforcing the document exchange application's security model.

The infrastructure security configuration portion 242 includes a common web server/file server setup. Commonly, to maximize storage space and simplify retrieval from multiple web servers, the files for a web based document storage application are stored on a separate file server. The web servers are typically connected to the file server using a virtual directory that connects with a user account that's valid on both servers. The virtual directory is pointed at the folder on the file server that contains the application's files.

The security system 230 of the document exchange application 220 includes a sub folder which corresponds to the folder on the file server that contains the application's files. The security system 230 grants access to the sub folder via a second user account. The account which is used to connect the virtual directory has no rights to the sub folder. The account that the web site runs under, and thus any web application such as the document exchange application 220, is given access to the sub folder.

The URLs of the files include the web server's URL, then the path to the virtual directory and the sub folder. Thus, the specified web server connects to the file server using the virtual directory and its account, then uses the account the web site runs under to gain access to the subfolder. In this way, only an application running under the website's user account can access the folder underneath the virtual. Manually typing in a URL to a file may connect through the virtual directory successfully, but won't be able to access the subfolder or any files within because the request is coming from the browser, and thus the user account of the person typing in the URL, and not an application that is authorized to use the web site account on the subfolder. This security configuration frees the need to further manage the security on the file server, and requires no operating system file level security management at all, as all rights can be inherited from the subfolder.

Accordingly, the files on the file server are secured from direct access by the security system, without requiring a secondary application, a client-side application, and with minimal security administration. The web site already connects through the virtual directory, so the processing overhead is not greatly effected. Administration involves a one-time setup of the virtual directory and the sub folder with the proper accounts.

Therefore, the security system provides a security configuration having small setup, no maintenance, and little overhead. The security system is transparent to the number of files and the number of potential users of the document exchange application 220, allowing any number of users on any number of webservers to upload and download files from a central fileserver, without allowing the users to directly access the files. Such a security system frees a document exchange application to use more flexible application code and allows a database to have as simple or complex a security algorithm as needed without involving any changes to the system configurations.

In operation, an internet information server (IIS) virtual directory is mapped from internet-accessible web servers outside of the firewall to a share folder on the file server 112, which is inside the firewall. An account is configured within the document vault database 140. The web server 112 virtual directories and the file server 116 share access to this database so that the web servers 112 can complete the connection to the file server 116. No further access is granted to this virtual-mapping account on the file server 116.

Inside the share folder, a second folder is created to be a document vault file storage folder. The account used to map the virtual directory to the actual document vault directory does not have access to this folder. The IIS account that the website uses (and therefore document exchange application 220 uses) has read/write/delete access to this file store folder.

When using the document exchange application 220, a user first authenticates with the LDAP 114 and then is connected to the web server 112 where the document exchange application 220 resides. The document exchange application 220 connects to the database 140 and uses the user's account and the user groups to determine the user's access level to files and folders.

To manipulate files, the web server 112 connects to the file server 116 through the virtual directory using the virtual-mapping account, then to the subfolder using the account under which the IIS website is running. Thus only the document exchange application 220 can access the file. The document exchange application 220 instantiates a server-side component. The server side component transfers the document file to or from the user through via the document exchange application 220. In this way, the server completes all of the file manipulation and transfers the file to or from the user's browser. The user is not presented with a direct link to the file, and never accesses the file server 116 directly.

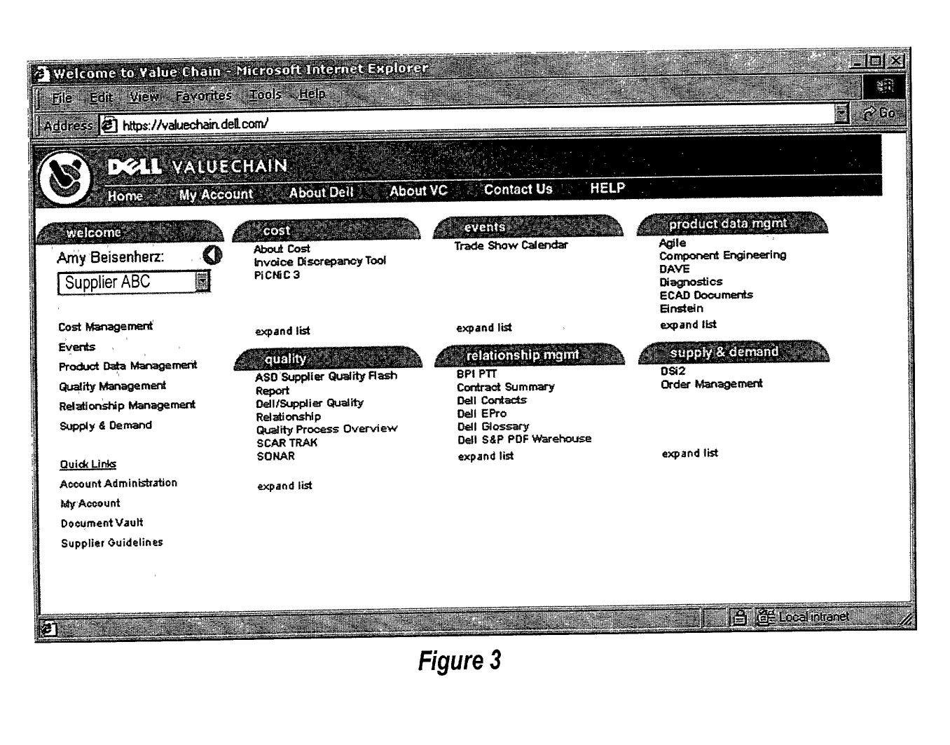

FIG. 3 shows a screen presentation of a front end of a program which provides access to document exchange application. For example, a user accesses the front end of the program by providing the appropriate URL (e.g., valuechain.dell.com). The user may then access the document exchange application by actuating the “Document Vault” portion of the screen presentation. When the user actuates the “Document Vault” portion of the screen presentation, the user is then transferred to a screen presentation of the front end of the document exchange application. It will be appreciated that many paths may be used to access the document exchange application.

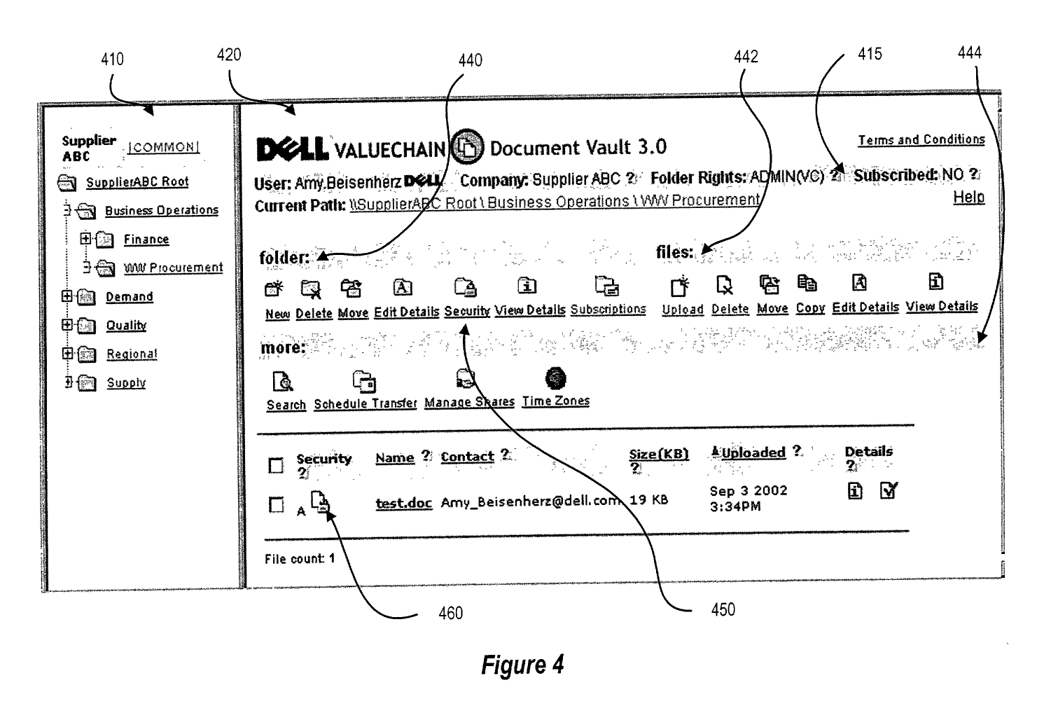

FIG. 4 shows a screen presentation of a front end of a document exchange application 220. The screen presentation includes a folder portion 410 and an information portion 415, as well as a document exchange functionality portion 420. The folder portion 410 provides a user with a list of available documents via a variety of folders. The functionality portion 420 includes an information portion 415, a folder function portion 440, a file function portion 442, an additional function portion 446 as well as a folder security portion 450 and a file security portion 460.

The information portion 415 provides information regarding the name of the user and the company associated with the user, the type of folder rights that the user has whether the user is subscribed to the current path. The information portion also identifies the current document path.

The folder function portion 440 provides a user with a plurality of folder functions. The folder functions include a new folder function, a delete folder function, a move folder function, a rename folder function, a security function, a details function and a subscriptions function.

The files function portion 442 provides a user with a plurality of file functions. The file functions include an upload file function a delete file function, a move file function, a copy file function, a rename file function and a details function.

The additional function portion 444 provides a user with a plurality of additional functions.

The folder security portion 450 provides a user with a security administration ability on a folder level. The file security portion 460 provides a user with a security administration ability on a file level.

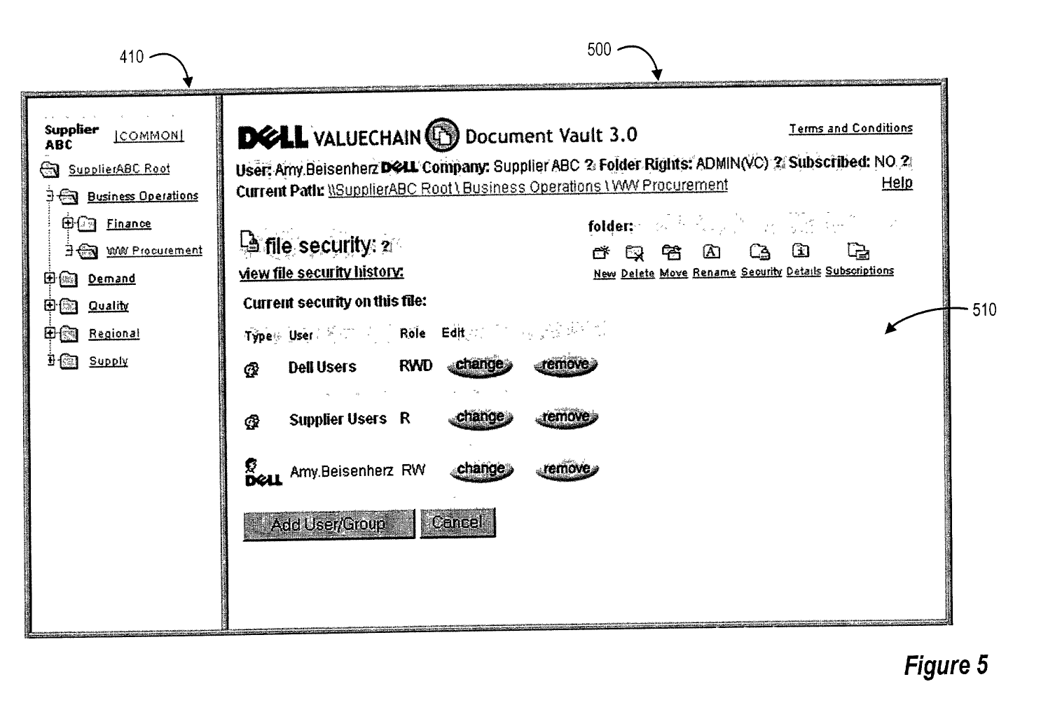

FIG. 5 shows a screen presentation of the folder security portion of a document exchange application. The folder security portion of the document exchange application 220 provides information regarding the current security of a particular folder. The folder security portion also provides an administrator with the ability to modify the current security on a particular folder. The information regarding the current security of the particular folder includes a list of users or groups that have access to the folder. The users may be internal users (e.g., “chris.davis”) or external users (e.g., jleggio). The group may be for example, suppliers of a device which correspond to the documents (e.g., “Supplier Users”).

The information also includes a role (i.e., a permission level) that a particular user or group has with respect to a particular folder. The role may be, for example, as an administrator (A), as a read-only user (R), as a download only user (D), a read write delete user (RWD), or read write user (RW).

A user or group may be edited by for example changing the user or group or by removing a particular user or group. A user or group can change from one permission level to another. Also, a user or group may be added; when adding a user or group, an administrator can designate a permission level.

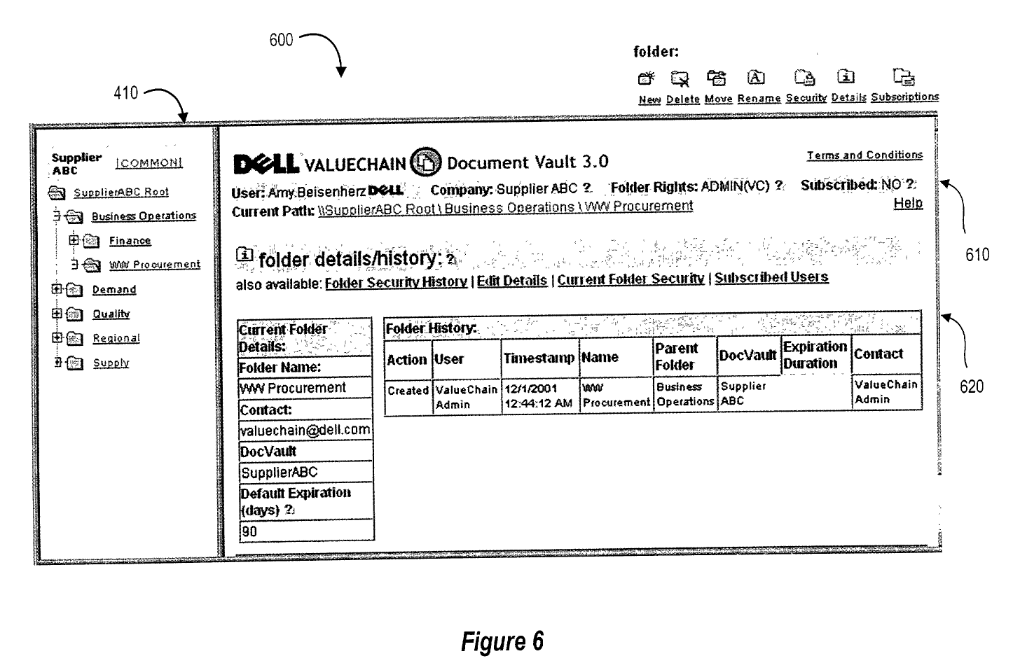

FIG. 6 shows a screen presentation of a folder detail/history portion of a document exchange application. The folder details/history screen presentation includes a current folder details portion 610 and a folder history portion 620. The current folder details portion 610 provides the folder name, the contact information of the person to contact regarding the folder and the document vault location. The folder history portion provides information regarding when the folder was created, who created the folder, when the folder was created, the name of the folder, the document vault location of the folder and the contact information of the person who performed the action on the folder (in this example, who created the folder).

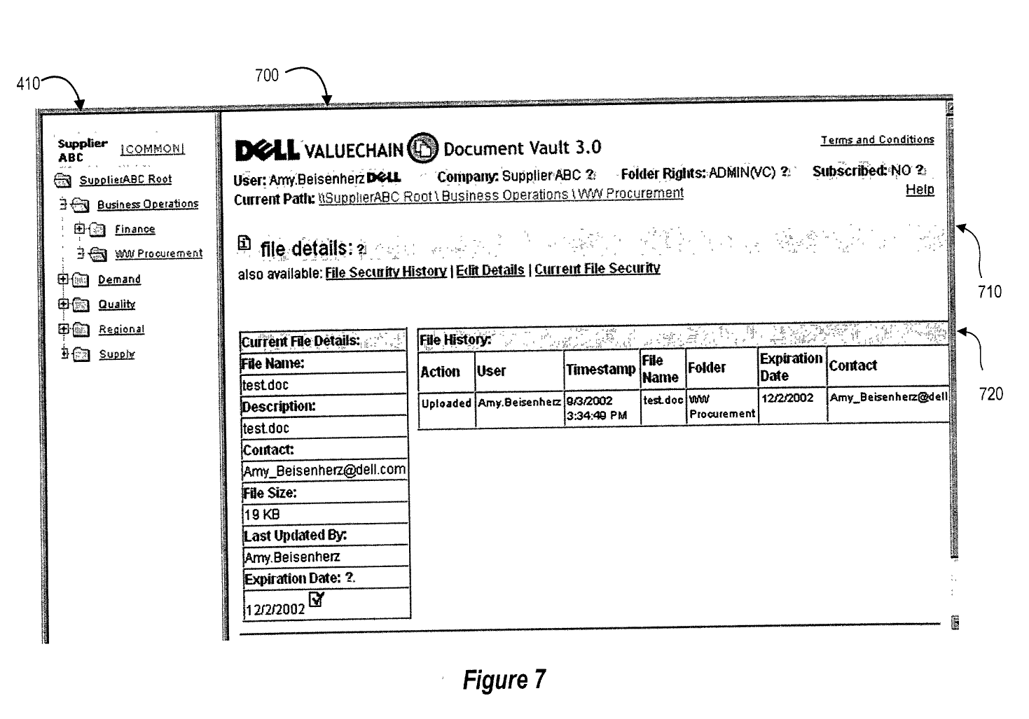

FIG. 7 shows a screen presentation of a file history portion of a document exchange application. The file details/history screen presentation includes a current file details portion 710 and a file history portion 720. The current file details portion 710 provides the file name, the contact information of the person to contact regarding the file and the document vault location. The file history portion provides information regarding when the file was created, who created the file, when the file was created, the name of the file, the document vault location of the file and the contact information of the person who performed the action on the file (in this example, who created the file).

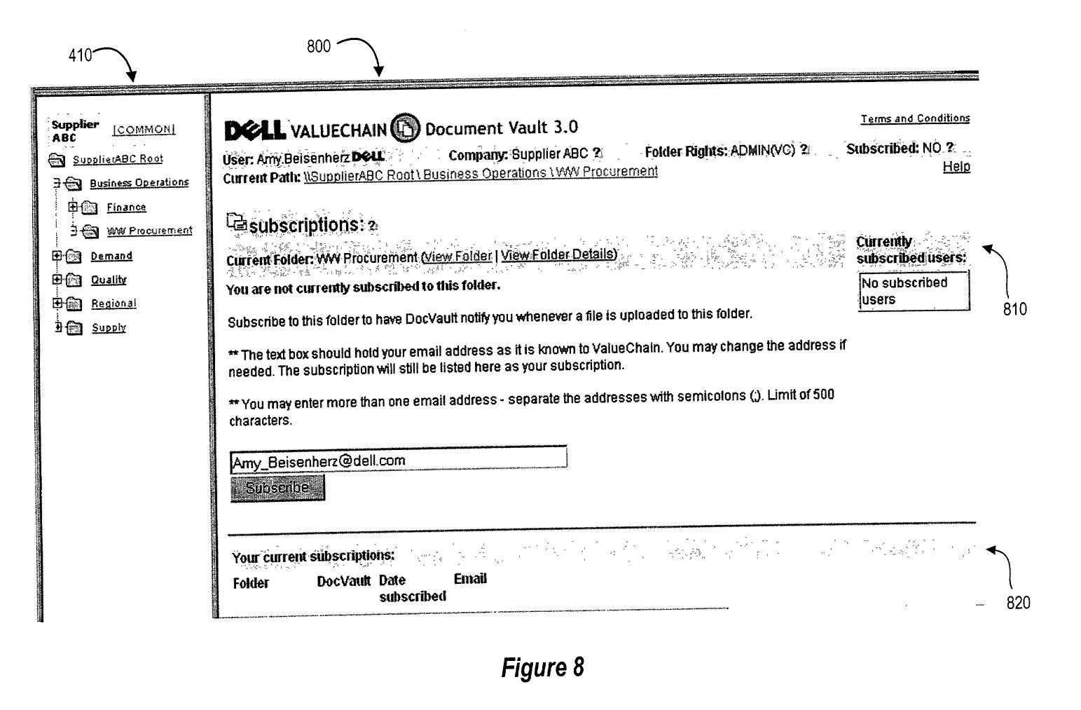

FIG. 8 shows a screen presentation of a folder subscription portion of a document exchange application. The folder subscription screen presentation includes a current folder subscriptions portion and a subscriptions information portion. The current folder subscriptions portion provides information to the user regarding whether the user is subscribed to the present folder. The subscriptions information portion provides information to the user regarding to which folders the user is presently subscribed.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A document exchange environment for allowing a user to access documents, the document exchange environment comprising:
a web server;
a document vault database coupled to the web server, the document vault database storing information regarding whether a user is authorized to access a document file;
a file server coupled to the web server, the file server, the file server providing a user access to the document file via the web server based upon the information regarding whether the user is authorized to access the document file.

2. The document exchange environment of claim 1 further comprising:
a document vault file store folder coupled to the file server, the document vault file store folder storing a plurality of document files.

3. The document exchange environment of claim 1 wherein:
the web server is accessed via a web browser.

4. The document exchange environment of claim 1 further comprising:
an authentication system coupled to the web server; and wherein the users access the web server via the internet using a web browser.

5. The document exchange environment of claim 4 wherein:
the authentication system conforms to a lightweight directory access protocol.

6. A document exchange application for enabling secure exchange of document files, the document exchange application comprising:
a security database and algorithm portion, the security database and algorithm portion providing access to information regarding whether a user is authorized to access a document file; and
an infrastructure portion, the infrastructure portion providing a user access to the document file based upon the information regarding whether the user is authorized to access the document file.

7. The document exchange application of claim 6 wherein:
the security database and algorithm portion and the infrastructure portion are included within a security system of the document exchange application.

8. The document exchange application of claim 7 wherein:
the infrastructure portion includes an infrastructure security configuration portion, the infrastructure security configuration portion preventing a user from bypassing the security system and directly accessing the document file.

9. The document exchange application of claim 8 wherein:
the security system includes a sub folder, the sub folder corresponding to a folder on the file server containing application files.

10. The document exchange application of claim 6 wherein:
the infrastructure portion includes a web server portion and file server portion, the web server portion being coupled to the file server portion using a virtual directory.

11. The document exchange application of claim 9 wherein:
the virtual directory points to a folder on the file server containing the document file.

12. An information handling system comprising:
a processor;
a memory coupled to the processor;
a document exchange application stored on the memory, the document exchange application including instructions coded to enable secure exchange of document files, the document exchange application including
a security database and algorithm portion, the security database and algorithm portion providing access to information regarding whether a user is authorized to access a document file; and
an infrastructure portion, the infrastructure portion providing a user access to the document file based upon the information regarding whether the user is authorized to access the document file.

13. The information handling system of claim 12 wherein:
the security database and algorithm portion and the infrastructure portion are included within a security system of the document exchange application.

14. The information handling system of claim 13 wherein:
the infrastructure portion includes an infrastructure security configuration portion, the infrastructure security configuration portion preventing a user from bypassing the security system and directly accessing the document file.

15. The information handling system of claim 14 wherein:
the security system includes a sub folder, the sub folder corresponding to a folder on the file server containing application files.

16. The information handling system of claim 12 wherein:
the infrastructure portion includes a web server portion and file server portion, the web server portion being coupled to the file server portion using a virtual directory.

17. The information handling system of claim 16 wherein:
the virtual directory points to a folder on the file server containing the document file.
